(19) United States
(12) Patent Application Publication
(10) Pub. No.: US 2007/0062921 A1
(43) Pub. Date: Mar. 22, 2007

(54) Full-body laser scribing method of fragile material

(75) Inventors: Norio Karube, Tokyo (JP); Hiroshi Miura, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: LEMI LTD., Yamato-shi (JP)

(21) Appl. No.: 11/520,020

(22) Filed: Sep. 13, 2006

(30) Foreign Application Priority Data
Sep. 13, 2005 (JP) 2005-264727
Mar. 29, 2006 (JP) 2006-089949

(51) Int. Cl. B23K 26/38

(52) U.S. Cl. 219/121.72

(57) ABSTRACT

This invention enables the full-body (throughout the entire thickness) scribing of a plate made of fragile material such as glass by irradiating the work with the laser beam for heating with or without cooling and thereby generating the tensile thermal stress in the work which exceeds the cleavage toughness of the material, dispensing with the mechanical breaking. In this invention, the absorption of the beam in the work is so controlled that the beam, while being absorbed in it, is either transmitted through it or reaches the adequate thickness of the work and the entire thickness scribing is realized. This absorption control is done by selecting the laser beam wavelength so as to achieve the proper absorption in the absorption spectra of the material either due to the electronic transition or the lattice vibration. The doping of the material, in which the commercially available high power laser beam can be absorbed properly and either of the absorption or emission in the visible light spectral range does not exist, can also be utilized for this absorption control. In this case, the quenching of the fluorescence which may arise after the beam absorption is useful. This invention enables the profile scribing of work or the selective scribing of piled work consisting of plural number of plates.

### TECHNICAL FIELD

This invention relates to the full-body laser scribing method of the fragile material such as glass, quartz, ceramics or semiconductor. In order to simplify the explanation, the case of processing glass is represented below.

### BACKGROUND TECHNIQUE

The cutting of fine glass used in flat panel displays which are in liquid crystal (hereafter abbreviated as LC) TV and plasma TV sets is presently performed using the conventional mechanical method, which is not free from the various kinds of problems such as the necessity of polishing, existence of micro-crack layer, etc.

The glass used in automobile, which is mostly round-shaped, requires polishing after the mechanical straight line cutting.

Tempered glass used in architecture is difficult to cut mechanically and requires a new processing method.

The advent of the laser technology, which can improve the quality and broaden the range of processing will be the solution to the various kinds of problem seen today.

Glass has been scribed so far using the mechanical method employing the ultra-hard tip such as made of diamond.

This method is accompanied by the following shortcomings. The first is the generation of caret which contaminates the glass surface. The second is the generation of micro-crack in the processed area, which weakens the mechanical strength of glass. The third is the existence of kerf, which is as wide as a few hundreds μm in the smallest case and cannot be neglected in the processing of extremely small work chips. The other factors such as the limit of processing speed and the cost of diamond tips cannot be neglected, either.

Different from the case of processing architectural glass plate, the scribing of fine glass plate such as being used in LC or plasma displays requires the subsequent polishing and cleaning procedures for removing micro crack zone.

On the other hand, the recently emerging laser scribing technology possesses the following advantages and is expected to eliminate the shortcomings possessed by the diamond tip method. The first is the caret-free processing characteristics and the cleaning process is not required. The second is the absence of the generation of micro crack, which results in high mechanical strength of scribed area and the subsequent polishing is not necessary. The third is the scribed surface, which is perfect as a mirror-polished one. The fourth is the highly accurate shaping geometry, the error of which is smaller than ±25 μm. The fifth is ability to withstand the ever decreasing thickness of glass plate, which will find application in the future LC TV.

Next, the principle of laser scribing is described. Let's consider the case of the irradiation of very high power CO₂ laser beam on the glass surface. Then the strong absorption of the beam takes place at the spot of the irradiation. The rapid local heating invites random and irregular but mostly radially distributed cracks, which cannot realize a controlled straight line scribing in the desired direction.

When the laser beam intensity is low enough only to heat the glass surface gently and not to change its property nor to melt it, then the glass, while struggling to expand but being pushed back by the surrounding glass, undergoes the concentric compressional stress, which is shown in FIG. 1(a). Here 7 is the work, 1 is the irradiated laser beam and 2 is the compressional stress. The last takes the maximum value at the beam center and decreases as the distance from the beam center increases. This value becomes zero on the boundary of the dotted circle (the distance from the beam center being R₁) as is shown in the figure. The stress is transformed into the tensile one 3 outside this circle with its direction being tangential. The strength of this stress first increases as a function of the distance, takes the maximum value at the distance of R₂ and then decreases monotonously as is shown again in the figure. This maximum value is selected as being below the cleavage toughness of the material. When the crack 5 is provided, the stress at its tip is magnified as being 4 in Fig. (a) and (b). This magnified value is selected to be greater than the cleavage toughness. Then the crack tip will be cleaved further and the scribing proceeds thereby. When the laser beam is scanned over the glass plate 7, the scribing proceeds on the straight line connecting the crack tip and the laser beam center. This is the controlled scribing, which is called “thermal stress scribing” of fragile material. This scribing is usually accelerated by applying the cooling procedure.

In the conventional laser scribing, a high power CO₂ laser beam has been used to irradiate the glass surface. Then the beam is absorbed only in the surface layer and the result is the surface scribing shown in FIG. 2 as the layer 9. In this case too, the existence of the crack is the prerequisite for performing the scribing and the scribing starts from the initial crack 8 prepared. The reason why the scribed layer extends only 100 μm in depth comes from the excessive absorption of the CO₂ laser beam by glass. Even by increasing the laser beam intensity, the scribed layer 9 cannot be deepened. In order to separate the glass plate completely, the application of a mechanical stress on the un-scribed plane 10 remaining underneath the scribed layer is required, which is called “mechanical breaking”. This conventional process using laser has not been rejected so far from the following reason. In the preceding mechanical scribing technology, the same procedure using the mechanical stress has been used without meeting any difficulty and people are used to it. This situation is illustrated in FIG. 3, in which the scribed layer of the similar depth is denoted as 11. In contrast to the case of the mechanical scribing, in which very poor processing quality is obtained, the laser scribing offers ideally high quality result both in laser scribed and mechanically broken layers. There is a clear boundary, however, seen microscopically between both the layers.

Over the past one century or longer, glass has been processed using the diamond tip scribing and the subsequent mechanical breaking. In this method, the existence of numerous micro cracks in the processed area shown in FIG. 3 enables the subsequent mechanical breaking. This breaking produces a low quality cut surface denoted as 12 in the figure. A high quality cut surface is not expected in this process because the subsequent polishing procedure can solve this problem.

In the presently used CO₂ laser scribing, the mechanical breaking is similarly necessary. Compared to the mechanical method, it has many advantages. The application, however, is limited due to the necessity of the subsequent breaking. On the manufacturing floor of LC TV sets, the CO₂ laser scribing method has not yet found active application. For it to be applied, some more problems such as securing higher positional accuracy, angular accuracy, cleanness, profile applicability, selective applicability in piled plate should be solved. The method solving all these problems has not yet been developed. The full-body scribing method of glass specified in this invention dispenses with the mechanical breaking and can solve all these problems.

### SUMMARY OF THE INVENTION

This invention is aimed to solve these problems and its purpose is to provide the method of the full-body scribing of the fragile material throughout the entire plate thickness dispensing with the subsequent mechanical breaking.

In this invention, the laser beam penetrates the adequate depth of the glass plate and in most cases entirely. In contrast to the CO₂ laser scribing in which the laser beam absorption is the surface phenomenon and the heat enters the glass plate only as the result of thermal conduction, this invention utilizes the laser beam which can penetrate the plate down to the bottom. FIG. 4 shows this difference. FIG. 4(a) shows the case of CO₂ laser scribing, in which the laser beam heat source 1 existing on the surface of the glass plate 7 is scanned in the direction of the arrow 15. The heat transfer in the direction of the plate thickness takes place as the result of heat conduction 13. In this invention, however, as shown in the figure (b) the heat source 14 is formed as the result of the absorption of the penetrating laser beam. The result is the full-body scribing and the mechanical breaking is not required any more. This condition enables the profile processing, which is the capability achievable only in the full-body scribing of this invention. Moreover, the distinction between the laser scribing and mechanical breaking does not exist on the cut surface, which is uniform and of high quality. The penetration of the laser beam can be realized by optimizing the absorption coefficient of the glass plate at the wavelength of the laser beam. The capability defined in this invention enables the selective scribing of each of the glass plates piled together.

The spirit of this invention can be summarized in the selection of the absorption coefficient of the glass at the wavelength of the laser beam as satisfying the following inequality of 0.105/L<a<18.42/L, where L (cm) is the thickness of the glass plate and a(cm⁻¹) is the absorption coefficient of the glass at the wavelength of the laser beam so that the absorption of the laser beam is not the surface but the bulk phenomenon and the resultant generation of the thermal stress causes, together with the application of proper cooling method, full-body splitting of the plate.

### BRIEF DESCRIPTION OF THE DRAWINGS

FIG. 1 is the diagram explaining the generation of compressional as well as tensile stress in the glass plate as the result of the material heating, which is caused by the laser beam irradiation. Figure (a) shows how compressional and tensile stresses are generated and the figure (b) shows how the intensity of the stress varies as a function of the distance from the laser beam center.

FIG. 2 is the perspective view showing the principle of the CO₂ laser beam scribing of glass plate.

FIG. 3 is the perspective view showing the principle of the mechanical scribing of glass plate.

FIG. 4 is the perspective view showing the generation of the heat within the glass plate when the laser beam is irradiated. Figure (a) is the case of the CO₂ laser beam irradiation and the figure (b) is the case of this invention, respectively.

FIG. 5 is the optical absorption spectrum of quartz which can be referred to in all the embodiments of this invention.

FIG. 6 is the diagram showing the three modes of laser beam absorption in the glass plate, which can be referred to in the understanding of the spirit of this invention.

FIG. 7 is the infrared transmission spectrum of non-alkaline glass, which can be referred to in the embodiment 3.

FIG. 8 is the diagram showing the wavelength characteristics of signal as well as idler as a function of the phase matching angle in a YAG laser optical parametric oscillator, which can be referred to in the embodiment 4.

FIG. 9 is the UV absorption spectra of various glasses, which can be referred to in the embodiment 6.

FIG. 10 is the optical absorption spectrum of Yb doped Na₂O.3SiO₂ glass, which can be referred to in the embodiment 8.

FIG. 11 is the optical absorption spectrum and laser oscillation spectrum of rare-earth element atom, which can be referred to in the embodiment 8.

FIG. 12 is the energy diagram showing a radiative transition as well as non-radiative ones, which can be referred to in the embodiment 8.

FIG. 13 is the optical transmission spectrum of Yb doped non-alkaline glass, which can be referred to in the embodiment 9.

FIG. 14 is the wavelength dependences of emission as well as absorption cross sections of Yb ion in germano-silicate glass, which can be referred to in the embodiment 9.

FIG. 15 is the perspective view of the laser scribing method in the embodiment 10.

FIG. 16 is the perspective view of another laser scribing method in the embodiment 10.

FIG. 17 is the perspective view of still another laser scribing method in the embodiment 10.

FIG. 18 is the perspective view of still further another laser scribing method in the embodiment 10.

FIG. 19 is the diagram showing the principle of the selective full-body laser scribing of piled glass plates, which can be referred to in the embodiment 11.

FIG. 20 is the plane view showing the formation of the initial cracks prior to the laser scribing in the glass plate, which can be referred to in the embodiment 11.

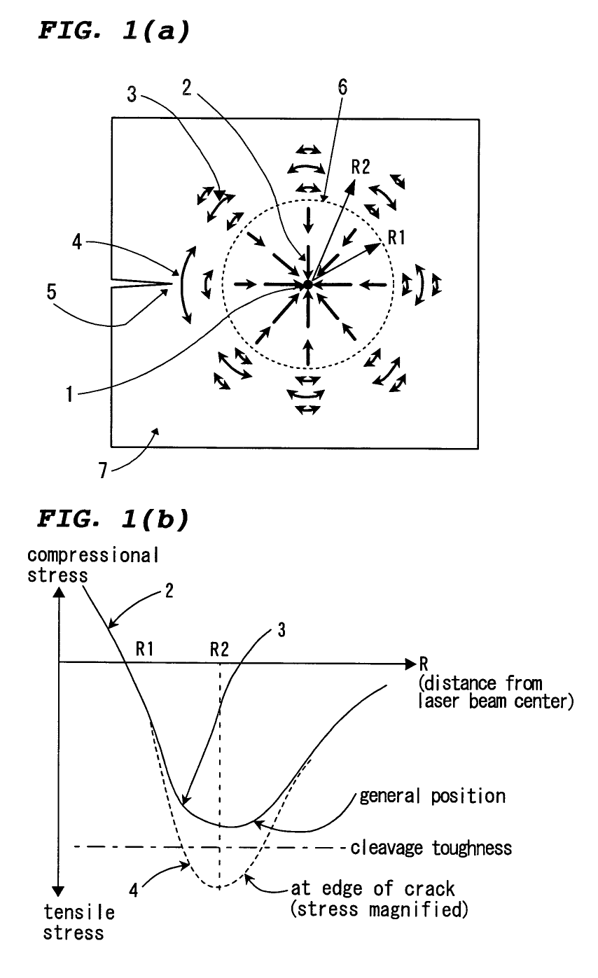

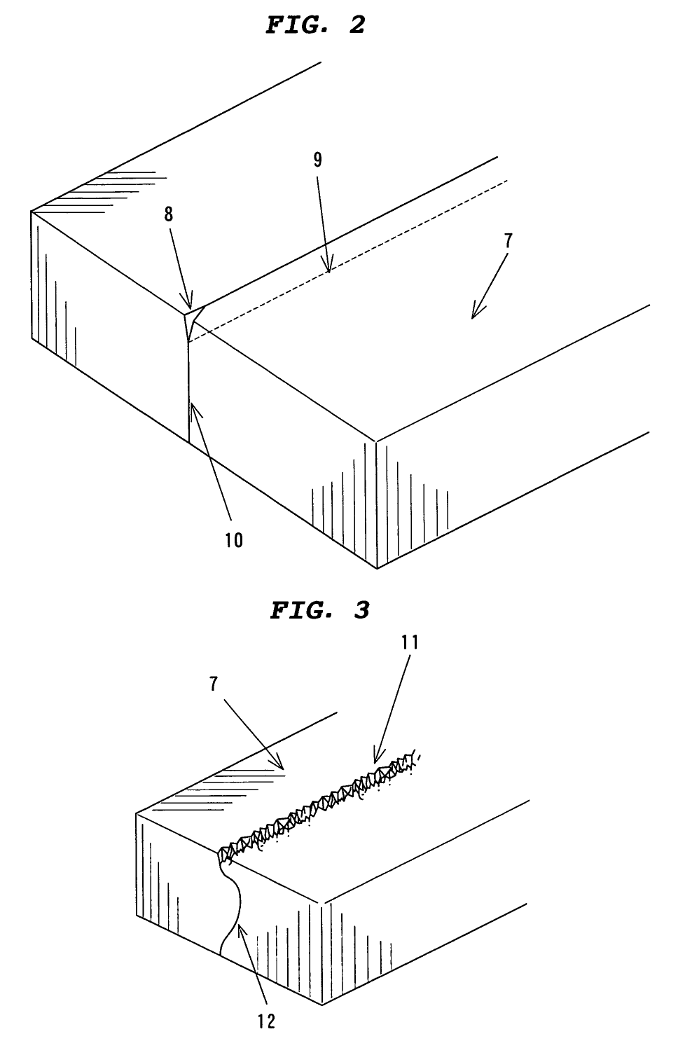

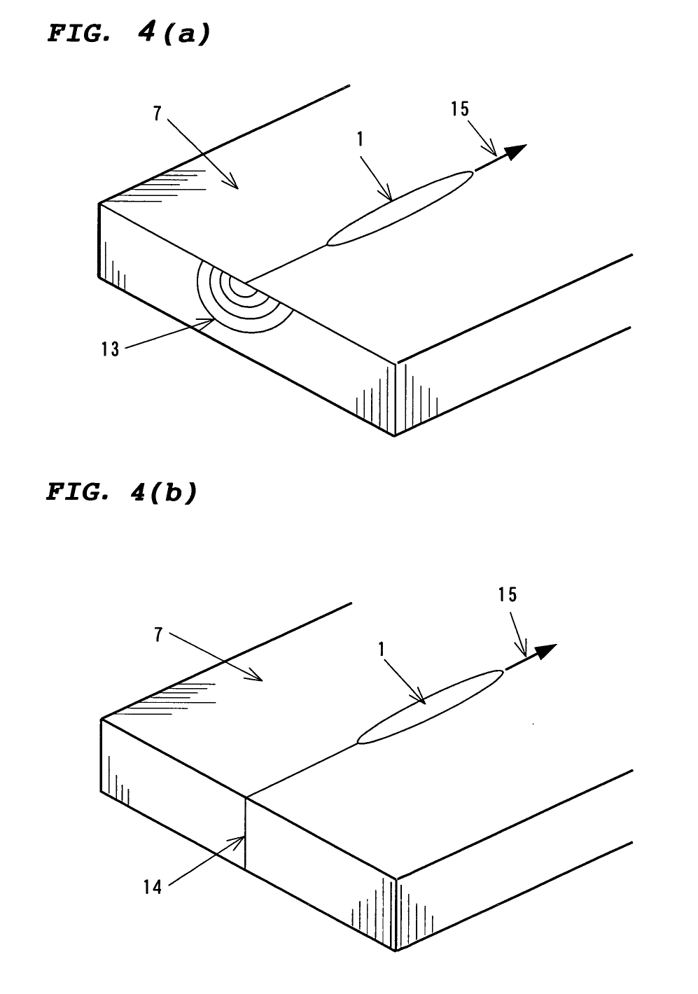

### BEST MODE FOR CARRYING OUT THE INVENTION

Exemplary embodiments of the present invention are demonstrated hereinafter with reference to the accompanying drawings.

### First Embodiment

Generally, the penetration of light within any material depends upon its absorption in it. Let's the absorption coefficient of the material be denoted by a (cm⁻¹), propagated distance by x (cm), the beam intensity before and after the propagation by I and I₀ respectively, the following relation holds.
I=I₀·e^{-ax} (1)

From Eq. (1), the necessary absorption coefficient can be determined in relation to the expected distance. Next, the maximum, optimum and minimum values of absorption coefficient proper in this invention are calculated

The minimum value is defined by the condition that 90% of the laser beam passes through the plate of the thickness L. Here, the majority of the laser beam energy is wasted but the full-body scribing can be secured. Putting I/I₀=0.9 in Eq. (1), we obtain a=0.105/L. We define this case as the minimum value of the absorption coefficient. We have often experienced that when the laser scribing is performed up to the thickness of one fourth, we could obtain the full-body scribing. We specify this case for the definition of the maximum value of a. Putting I/I₀=0.99 and x=L/4 in Eq. (1), we obtain a=18.42/L, which corresponds to the maximum value. The optimum case corresponds to the one in which 50% of the laser beam is absorbed by the glass plate. Eq. (1) then gives a=0.693/L.

Table (1) gives these maximum, optimum and minimum values of the absorption coefficient for the typical three glass plate thicknesses of 0.02 cm (value for future LC TV), 0.07 cm (value for present LC TV) and 0.28 cm (value for present plasma TV).

TABLE 1
Desirable absorption coefficient for various glass
plate thickness

| | Min value | | |
|---|---|---|---|
| Thickness | (cm⁻¹) | Optimum value (cm⁻¹) | Maximum value (cm⁻¹) |
| 0.02 cm | 5.25 | 34.65 | 921 |
| 0.07 cm | 1.50 | 9.90 | 263 |
| 0.28 cm | 0.38 | 2.48 | 65.8 |

The absorption coefficient is proper to material and is the function of the wavelength. Generally, when the material to process is selected, the parameter which can be changed is wavelength only. FIG. 5 shows the absorption spectrum of quartz shown as a function of wavelength. The vertical axis is the extinction coefficient K, which is given by the relation a=4pκ/λ. The figure shows that the absorption coefficient a of quartz for the wavelength 10.6 μm of the CO₂ laser beam is of the order of 12600 cm⁻¹. According to Eq. (1), 99% of the CO₂ laser beam will be absorbed after the beam propagation of only 3.7 μm from the surface of the glass plate. This means that only the surface layer undergoes the laser beam penetration. However, actually, the surface layer of about 100 μm can be scribed, which is enhanced by the thermal conduction.

The compositions of commercial products of glass differ from manufacturer to manufacturer, which is different from the case of crystals. However, the absorption characteristics shown in FIG. (5) can be referred to in most cases. In the figure, the absorption coefficient a is given as a function of wavelength. According to it, the absorption coefficient at the wavelength of CO₂ laser beam, i.e. 10.6 μm, is too large. In order to change the absorption coefficient a, it is necessary to change the wavelength. However, the wavelength of all the high power lasers cannot be varied continuously. The wavelengths of the typical high power lasers available today are summarized in Table 2.

TABLE 2
Typical high power lasers and oscillating wavelengths

| | | |
|---|---|---|
| 10.6 | μm | (CO₂ laser) |
| 5 | μm band | (Co laser) |
| 2.94 | μm | (Er:YAG laser) |
| 2.09 | μm | (Ho:YAG laser) |
| 1.06 | μm | (Nd:YAG laser) |
| 1.03 | μm | (Yb:YAG laser) |
| 0.530 | μm | (Second harmonics of Nd:YAG laser beam) |
| 0.353 | μm | (Third harmonics of Nd:YAG laser beam) |
| 0.265 | μm | (Fourth harmonics of Nd:YAG laser beam) |
| 0.212 | μm | (Fifth harmonics of Nd:YAG laser beam) |

In the application of any laser, it is possible to select the wavelength only from among the above.

The following three modes exist in the absorption of laser beam in the glass plate.
1) The case of excessive absorption (CO₂ laser is the typical example)
2) The case of deficient absorption (YAG laser is the typical example)
3) The case of optimum absorption (this invention is the typical example)

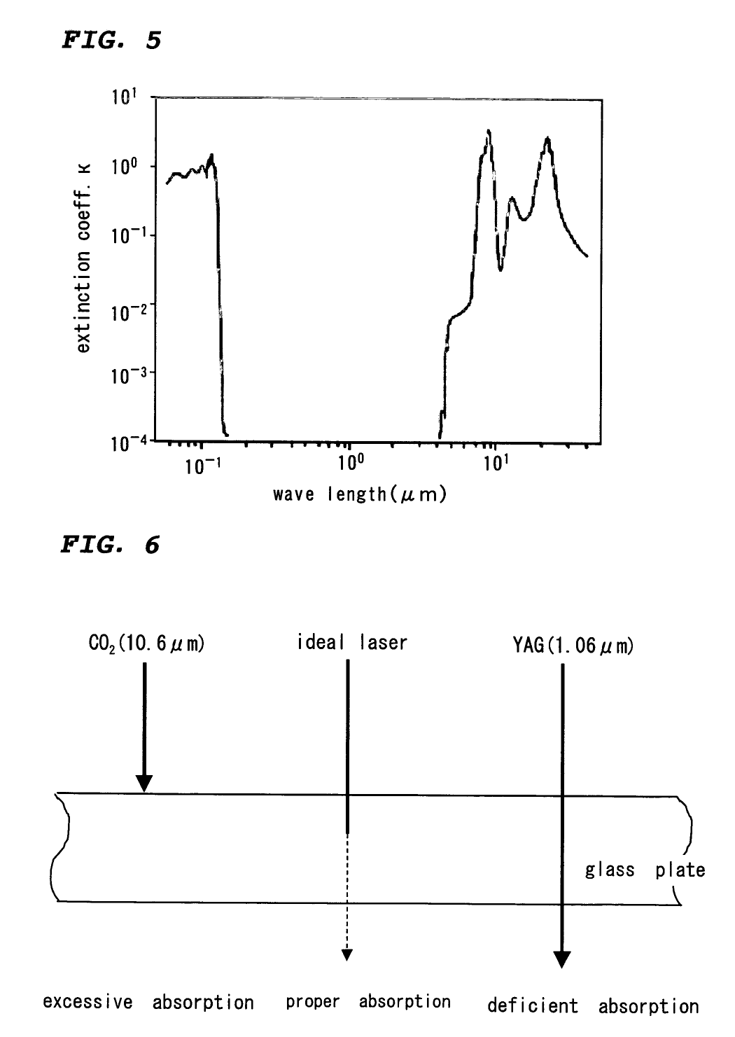

FIG. 6 is the diagram showing these three modes.

As is shown in the figure, CO₂ laser performs the excessive absorption and, therefore, cannot be used for full-body scribing of glass. However, it is the typical high power laser developed for material processing. When the output power is adequately high, this laser beam can penetrate the glass plate as a result of thermal conduction. The embodiment 1 is the full-body scribing realized by this mechanism. Especially when the plate thickness is small, this method can be applied. The thermal conduction takes place not only in the thickness direction but in all the direction, too. In order to realize the conduction in the thickness direction, a large beam width is required. Of course the trade-off between this factor and beam concentration should be considered.

So far, the method of heating the work has been considered. In order to realize the full-body scribing, the cooling in the thickness direction should better be done. The cooling from both the surfaces, i.e. front as well as rear, should better been done. It is correct in all the embodiments of this invention.

### Second Embodiment

Next one example of the usefulness of selecting the wavelength is given. In the embodiment 2, the use of CO laser beam oscillating in the 5 μm band in stead of CO₂ laser is explained. This laser is relatively feasible because a CO₂ laser can be converted into this laser by changing the laser gas and cavity optics. A CO laser generates the beam, the wavelength of which extends in the band between 4.9 μm through 5.7 μm. According to FIG. 5 the absorption coefficient of quartz at 5 μm is 62.85 cm⁻¹. Then according to Eq. (1), 99% of the laser beam is absorbed in the glass plate of the thickness of 0.7 mm. The full-body scribing of the glass plate 7 can be done with a CO laser, although a lower absorption coefficient is more desirable. As the thickness of the glass plate used in the LC panels decreases monotonously, this method to use a CO laser will become more useful in the future.

### Third Embodiment

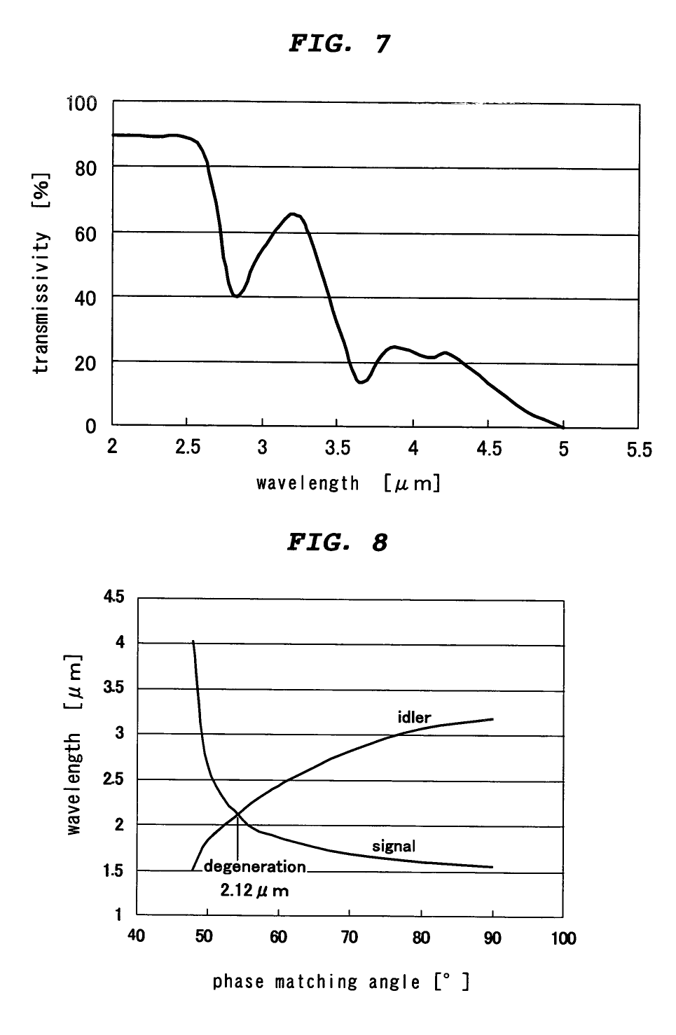

It is possible to increase the transmission of the laser beam within the glass thereby realizing an ideal full-body scribing. Glass is transparent in the visible wavelength range and generally shows absorption both in the UV ad infrared ranges. FIG. 7 shows the transmission characteristics as a function of wavelength for 0.7 mm thick non-alkaline glass which is used in LC TV. The vertical axis of this figure is the transmissivity T (%). Neglecting Fresnel reflection on the glass surface, Eq. (1) gives the value of a from the relation of T=I/I₀=e^{-0.07a}. In contrast to the case of crystal, the composition and structure of which are fixed, the composition of any commercial glass varies from manufacturer to manufacturer. We can refer to the transmission characteristics shown in FIG. 7 in the first order approximation. Then we can obtain the absorption coefficient of non-alkaline glass in the wavelength range between 2.5 μm and 4.6 μm to be 2.3 cm⁻¹ to 40 cm⁻¹. On the other hand, the appropriate absorption coefficient to full-body scribe the non-alkaline glass plates of various thicknesses is known to coincide with these values, the laser beam, the wavelength of which is included within this wavelength range, can be selected for performing the full-body scribing of non-alkaline glass plate. Unfortunately, however, the high power lasers developed so far were for processing metal works, for which the wavelength selection is not required, we do not presently find any commercial laser products covering these wavelengths.

One commercial product included in this wavelength range is an Er:YAG laser of the wavelength of 2.94 μm. This laser generates the output power up to 3 W and is applied in the dental therapy. The embodiment 3 is the proposal to power-scale this laser up to 100 W power level, which can realize the full-body scribing of non-alkaline glass. In the parallel use of adequate number of 3 W lasers, too, optical fibers composing a fiber bundle as a whole are connected to each lasers, the other ends of which are so arranged with focusing optics as to form the appropriate beam cross section for achieving the full-body scribing.

### Fourth Embodiment

The laser beam of the wavelength of around 3 μm can also be obtained as the third harmonics of CO₂ laser beam or from the optical parametric oscillation using YAG laser beam. Due to the recent progress of non-linear optical crystals, the latter is fairly feasible. The embodiment 4 utilizes this technology. The required power of the beam comes, in this case, from those of the signal and idler in the parametric oscillation realized by the irradiation of YAG laser beam onto a non-liner optical crystal. FIG. 8, which is the quotation from “Solid-State Laser Engineering” (Fifth Edition Springer-Verlag 1999) written by Walter Koechner, shows the wavelength characteristics of the signal and idler of an optical parametric oscillator of the type II angular phase matching shown as a function of phase matched angle, in which 1.06 μm YAG laser beam is irradiated onto a KTP crystal for excitation. The optical parametric oscillation of this kind covers the wavelength range extending between 1.6 μm and 4 μm, which is appropriate for obtaining the absorption coefficient of 2.4 cm⁻¹ to 35 cm⁻¹ in non-alkaline glass, which is further required to cover the thickness range of 0.02 cm to 0.28 cm of this glass plate. In this technology, the different plate thickness can be dealt with by changing the phase matching angle, thereby obtaining the appropriate wavelength and absorption coefficient, and the beam power. This requirement of changing the phase matching angle only simplifies the entire configuration of the device in which different thickness can be dealt with.

We know from our experience that the 100 W CO₂ laser beam is required to surface-scribe 0.7 mm thick non-alkaline glass plate. This power is entirely absorbed in the glass plate as the beam's absorption coefficient is extremely high. The optimum absorption case mentioned above corresponds to 50% absorption in the work. Therefore, 200 W laser beam power is required in the optimum case. Presently, the achievable power in the optical parametric oscillator is of the order of a few tens W. The application of the quasi-phase matching in the periodic depolarization inverted structure promises the power enhancement and achieving 200 W will be feasible.

### Fifth Embodiment

The embodiment 5 proposes realizing the laser beam possessing the appropriate wavelength from a mixed crystal semiconductor laser in which the composition is so selected as to obtain the desired oscillation wavelength.

It is general that the lattice parameter as well as band-gap come closer to the values of the compound semiconductor of the dominant composition when two different compound semiconductors are mixed as a mixed crystal semiconductor. As an example, take the case of In(AsₓSb₁₋ₓ)_{y}P_{1-Y} composed of the III-V compound semiconductors of x and y compositional ratio. When y=0, the lattice parameter becomes minimum and the band-gap maximum, while the opposite case holds when x=0 and y=1. The wavelength of the beam from this mixed crystal semiconductor laser can cover the wavelength range of 2 μm to 4 μm. Similar case holds for In₁₋ₓGaₓAs_{y}Sb_{1-y} or Al₁₋ₓInₓAs_{y}Sb_{1-y}. On the other hand, the mixed crystal semiconductor laser composed of IV-VI Pb₁₋ₓEuₓSe_{y}Te_{1-y} generates the wavelength range of 2.6 μm to 6.6 μm.

As these wavelengths correspond to full-body scribing non-alkaline glass, it is possible to perform the full-body scribing of the non-alkaline glass plates of various thickness. However, here, a simple procedure such as changing the phase matching angle mentioned in the previous section to cover different thicknesses does not exist. In this embodiment, the adequate number of different kinds of lasers to cover the required wavelength range should be prepared beforehand and should be selected for dealing with each plate thickness.

### Sixth Embodiment

The embodiments described so far utilize the beam absorption of glass in the infrared spectrum. This material possesses the absorption property on the other side of spectrum, i.e. UV range.

Here the absorption arising from the transition from the filled band to conduction band of bound electrons of oxygen ions in glass can be realized by the irradiation of third harmonics, fourth harmonics as well as fifth harmonics of rare-earth element laser beam.

The embodiment 6 is the proposal to utilize the UV absorption arising from this principle, in which either of third harmonics, fourth harmonics or fifth harmonics of rare-earth element laser beam is selected so as to realize the required absorption in each case. The UV absorption in glass takes place in oxygen ions in glass and glass becomes transparent to the shorter wavelength as ions are bound more strongly.

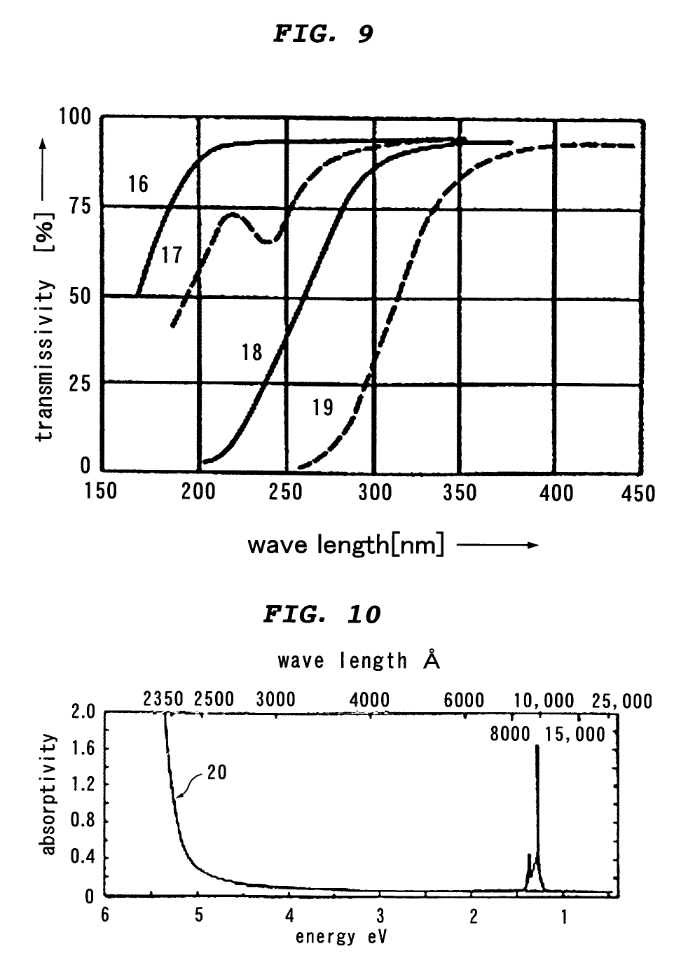

FIG. 9 is the quotation of FIG. 108 on page 233 in the book “Glass Nature, structure and properties (Springer-Verlag)” written by Host Scholze. The curves 16 to 19 in the figure correspond to extremely pure SiO₂, ordinary SiO₂, extremely pure Na₂O.3SiO₂ and ordinary Na₂O.3iO₂ respectively. This figure shows that the wavelength range covering 50% transmission in the 10 mm thick plate extends between 160 nm to 320 nm. The beam within this range can be obtained from either of the third, fourth and fifth harmonics of the laser beam using the rare-earth atom doped crystals. The wavelength candidates include 353 nm, 265 nm, 212 nm all from Nd:YAG laser, 343 nm, 258 nm, 206 nm all from Yb:YAG laser, 349 nm, 440 nm, 262 nm, 330 nm, 209 nm, 264 nm all from Nd:YLF laser. Good selection among these candidates for achieving proper absorption in view of the thickness and composition of the work can realize the full-body scribing.

### Seventh Embodiment

In the embodiments described so far, the full-body scribing is performed utilizing the laser beam absorption inherent in the glass. The disadvantage of this technology is that the absorption characteristics of glass does not coincide with the oscillation wavelengths of the commercial lasers. This problem can be solved by varying the absorption characteristics represented by the one shown in FIG. 5. It can be done by doping the glass plate 7. The selection of the dopant should be done in such a way that it does not change the visible spectral characteristics of the material and does not influence the display function of the device. The dopant should absorb the irradiation beam properly and via a non-radiative transition should generate the heat necessary for scribing. It should not generate either of optical absorption or emission in the visible spectral range. As the wavelength selection becomes less restrictive, the selection of the irradiation laser can be done in the list of the commercial products. The embodiment 7 applies this technology.

Next this technology will be explained with examples. It is possible to perform the full-body scribing in glass 7 by doping it with the proper amount of water (H₂O), which possesses the absorption band coinciding with the oscillation wavelengths of Er:YAG laser and Ho,Tm:YAG laser and by irradiating the glass with either of these laser beams. More specifically, this technology utilizes the infrared absorption bands of 2 μm and 3 μm of water, which coincide with the oscillation wavelengths of 2.091 μm of Ho,Tm:YAG laser and 2.94 μm of Er:YAG laser respectively. This doping technology assures higher absorption rate and can reduce the required power of the irradiation laser beam, which is the difference from the technology shown in the embodiment 3.

In order to dope the glass plate 7, the simplest way is to expose the plate to high temperature and high pressure water vapor. Then the plate will contain water of a constant concentration. By keeping this condition for a long time, the colloidal gel containing water is formed or the state called as hydroceramic is formed. Roger F. Bartholomew published the article of “High-water containing glasses” on pages 331 to 342 in Journal of Non-Crystalline Solids, Vol. 56 (1983) and discussed the nature of the glass containing a high concentration water. In this article, he quoted the following finding of Scholze. There exists at 6.2 μm the absorption due to H—O—H bending, at 4.2-3.6 μm the one due to hydrogen bond, at 2.8-2.7 μm the one due to Si—OH and H—OH stretching, at 2.22 μm the one due to Si—OH overtone of stretching and bending combination, at 1.9 μm the one due to H—O—H overtone of stretching and bending combination and at 1.4 μm the one due to Si—OH and H—OH overtone of stretching. As these absorption are caused by stretching and bending between bonded atoms, in which the radiative decay is absent, all of the absorbed infrared energy is converted into heat and generates thereby the thermal stress in the glass.

The absorption coefficient of this kind is proportional to the water concentration. Therefore, by realizing the water concentration distribution determined from the plate thickness which assures the beam absorption and heat generation uniform in the direction of the thickness, the desirable heat source can be realized. The Ho, Tm:YAG laser oscillating at the wavelength 2.091 μm is a good candidate for this technology. The beam of this wavelength can be absorbed by H—O—H overtone of stretching and bending combination.

The other candidate is Er:YAG laser oscillating at the wavelength of 2.94 μm corresponding to Si—OH and H—OH stretching. The water doping, while it causes the infrared absorption, does not affect the visible spectral characteristics and, therefore, does not deteriorate the display function. Furthermore, the same doping hardens glass, which prevents the occurrence of crack.

In the embodiment 7, the heat source is the penetrating type. In order to reduce the laser power as much as possible, the cross sectional dimension should be small. A disk laser oscillator of an excellent beam quality is a good candidate.

### Eighth Embodiment

The embodiment 8 is the proposal in which the procurement of the irradiation laser is easy. It is the method that a rare-earth element atom such as Nd, Yb, Ho or Er is doped in the glass and the corresponding rare-earth element laser is to be used for irradiation. Here the inversely exponential distribution of the dopant will realize the heat generation, which is uniform in the direction of the plate thickness. This condition is useful in all the embodiments in which doping is performed.

Rare-earth element atoms possess sharp absorption and fluorescence lines arising from the insensitivity of the f electrons in N shell to the lattice field as they are surrounded by electron group in outer O shell and are suitable to be used for laser oscillation. The Nd:YAG, Yb:YAG, Ho,Tm:YAG and Er:YAG lasers are as such.

For realizing the full-body scribing, one of those rare-earth element atoms, such as Yb for instance, is doped into the glass and the corresponding rare-earth element atom laser, Yb:YAG laser in this case, is used for irradiation.

H. L. Smith and A. J. Cohen published the article “Absorption spectra of cations in alkali-silicate glasses of high ultra-violet transmission” in Physics and Chemistry of Glasses Vol. 4 (1963), No. 5, on pages 173 to 187 and reported the measured absorption coefficient of the glass doped with either of Pr, Nd, Sm, Eu, Gd, Tb, Dy, Ho, Er, Yb or U. One example is shown in FIG. 10, in which the absorptivity of 4.92 mm thick Na₂O.3SiO₂ glass plate doped with 3.7% Yb is shown. The doping of Yb ( or Nd) in this glass generates the absorption line around 1 μm, which coincides with 1.03 μm of Yb:YAG laser beam or 1.06 μm of Nd:YAG laser beam. Similarly, Na₂O.3SiO₂ glass doped with Ho or Tm possesses the absorption line around 2 μm, which coincides with 2.091 μm of Ho,Tm:YAG laser beam.

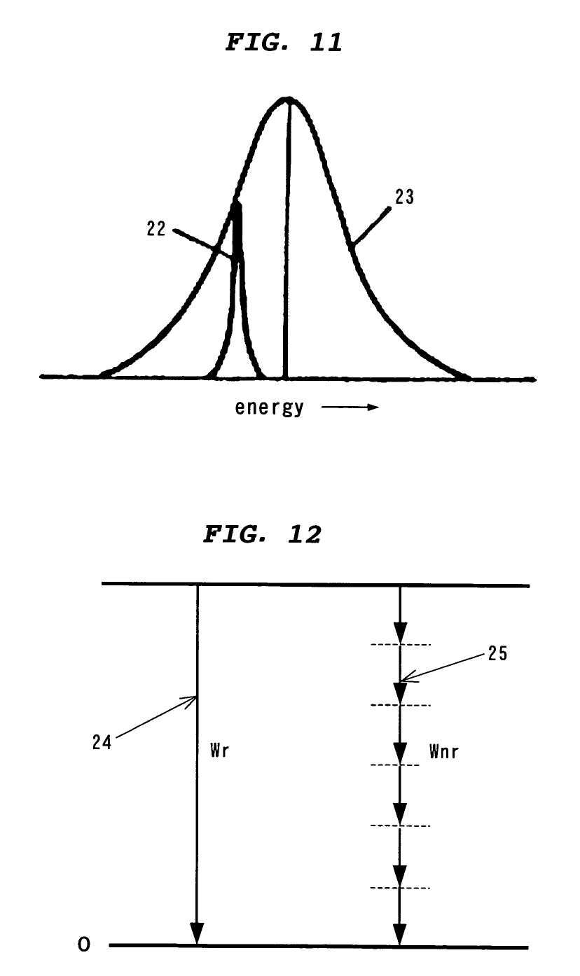

There may exist the wavelength difference of about 100 nm between absorption and laser oscillation of rare-earth element atom. This situation takes place as the result of the variation of the crystal field influencing the behavior of the atom in each elementary crystals composing the entire glass plate. This phenomenon causes the inhomogeneous broadening of the absorption line. One example of it is shown in FIG. 11, which is the quotation from FIG. 7.6 in the book “Optical and spectroscopic properties of glass” (Springer-Verlag) on page 158 published by G. Fuxi. In this figure, the curve 23 is the inhomogeneously broadened absorption line which includes the entire part of the laser oscillation line 22. The latter can be completely absorbed by the former.

It is, therefore, possible to control the absorption coefficient of the glass which is doped with rare-earth element atom and is irradiated with the laser beam of the corresponding rare-earth element atom. However, the rare-earth element atom excited by light absorption may, at high probability, deactivate by fluorescence back to the ground level and does not generate heat. In this invention, the occurrence of this fluorescence should be quenched. It can be done by doping the quencher of a rare-earth element atom possessing multiple energy levels, the gap of which is much smaller than that of the fluorescence.

G. E. Peterson and P. M. Bridenbaugh showed the effectiveness of the quenching function of a rare-earth element atom such as Pr, Sm and Dy for the excited Nd in the article “Study of relaxation process in Nd using pulsed excitation” in Journal of Optical Society of America, Vol. 54 (1964), on page 644 to 650. Therefore, the Nd doped glass irradiated with Nd:YAG laser beam, when one of these atoms is doped together, undergoes the heat generation via a non-radiative transition and can realize the full-body scribing. These quenchers can also be used for the glass doped with Yb and irradiated with Yb:YAG laser beam. In the case of the combination of Ho,Tm:YAG laser and Ho or Tm doping, Pr, Nd and Eu possessing multiple energy levels corresponding to smaller gap can be used as the quencher. In this case, the probability of non-radiative transition increases due to smaller energy gap as described by G. Fuxi in his previously mentioned book on page 192.

FIG. 12, which is the quotation from FIG. 7.4 on page 156 in the same book, shows that the probability of non-radiative transition heat generation Wnr increases for smaller energy gap. The other quenching method is the use of concentration quenching, which is the case of excessive doping for absorption. This method is useful in all the cases described here. The concentration of this dopant, on the other hand, should be optimized in view of the plate thickness, which limits this quenching actually.

Especially in the case of Nd and Yb doping, Nd:YAG laser and Yb:YAG laser can be used for irradiation, which eases the procurement of the irradiation laser up to the power level of a few kW. The quenching can be done by Pr, Sm or Dy doping or by concentration quenching using Nd and Yb.

### Ninth Embodiment

The embodiment 9 is the proposal in which the procurement of the irradiation laser becomes further easier. Here again the dopant is a rare-earth element atom and the 4f electron in the rare-earth element ion in the glass is excited by the LD beam, which results in the heat generation via a non-radiative transition. The LD to be used here is available commercially, being manufactured in big volume for pumping solid state lasers. The overall energy efficiency is at least two times higher as we can skip the process of pumping a laser.

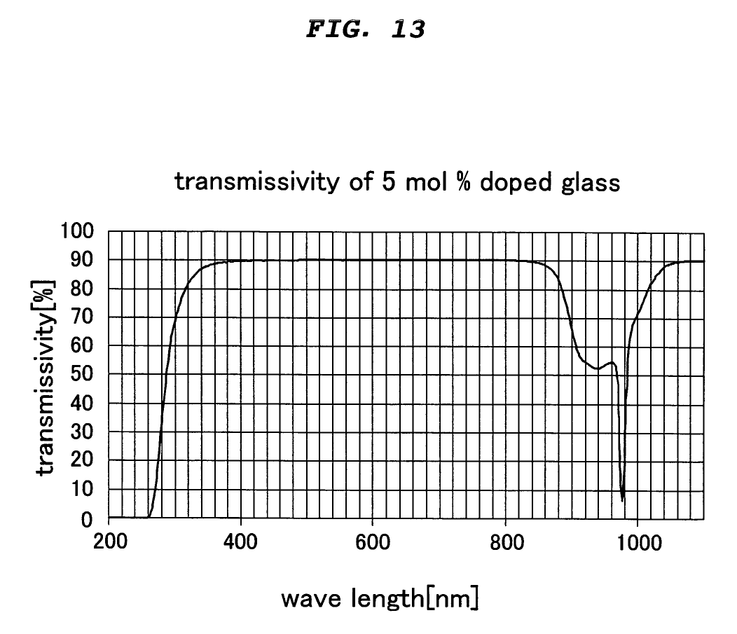

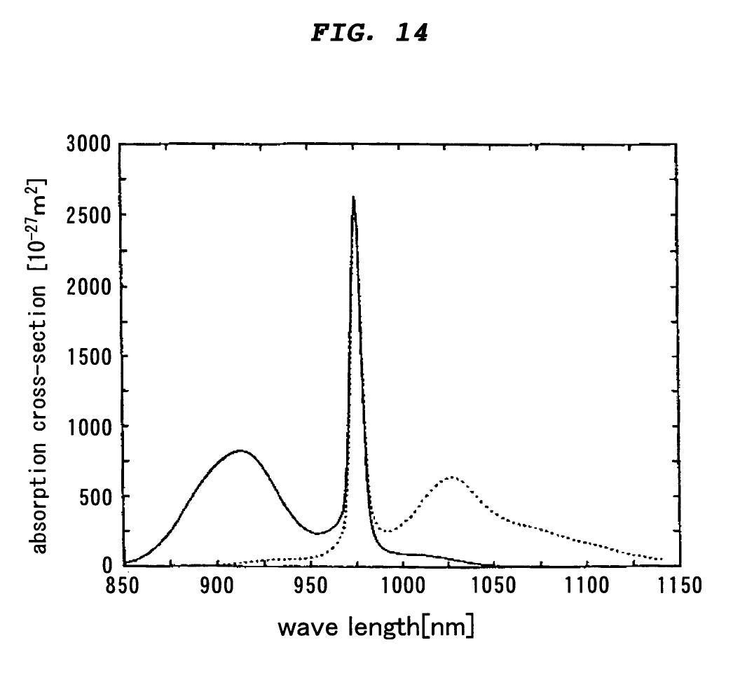

The typical dopant is Yb. As its energy levels are composed of the ground level consisting of numerous sub levels and one upper level, the doping of it produces some absorption lines in the infrared range of 900 μm to 1050 μm and does not produce any other absorption lines including those in the visible range. FIG. 13 shows the spectral transmission characteristics of the 5 mol % Yb doped glass plate prepared by us. The Yb doped glass, which is transparent, can be used in flat panel displays. As the Yb atom is stable with f electrons in N shell being surrounded by electron group in outer O shell, this dopant does not change the physical and chemical properties of glass for a long time period. The germano-silicate glass doped with Yb atom shows the absorption band peaked at 975 nm, the absorption cross section of which was reported to be 2.7×10⁻²⁰ cm² by Rudiger in his article “Ytterbium-doped fiber amplifiers” published in IEEE Journal of quantum electronics, Vo. 33 (1997), No.7 on page 1049 to 1056. FIG. 14 shows the absorption cross section (solid line) and the emission one (dotted line). The InGaAs semiconductor laser, the composition of which is selected to match the absorption line, together with the doping of Yb of the concentration matching the absorption selected for the particular plate thickness will realize the full-body scribing.

Next, the procedure to obtain the optimum absorption coefficient for a given plate thickness is explained in the case of the doping in the form of Yb₂O₃. Let's assume the following parameters in the case of doping of 1 wt. % Yb₂O₃.

Composition: SiO₂:60%, Al₂O₃:20%, B₂O₃:19%, Yb₂O₃:1%

Density: ρ=2.51 g/cm³

In this composition 1 molg is calculated to be 85 g and the concentration of Yb is given as,
Yb concentration=3.56×10²⁰ (atoms/cm³) (2)

Using the previously introduced Rudiger's data of the absorption cross section of Yb at the wavelength of 975 nm, the absorption coefficient a of the glass doped with 1 wt % Yb₂O₃ is calculated as 9.6 (cm⁻¹). Assuming the optimum absorption of 50%, the glass thickness L and the optimum weight ratio of Yb₂O₃ x satisfy the following relation,
X×L=0.072 (3)

This relation gives the following optimum weight ratio x of Yb₂O₃ to be doped in non-alkaline glass for different plate thickness as shown in Table 3.

TABLE 3
Optimum Yb₂O₃ weight ratio for various plate thickness
of non-alkaline glass

| Thickness (cm) | x (%) |
|---|---|
| 0.02 | 3.6 |
| 0.07 | 1.0 |
| 0.28 | 0.2 |

In the above, the optimum weight ratio x of the dopant Yb₂O₃ in non-alkaline glass realizing 50% absorption of the InGaAs laser beam for the plate thickness L has been obtained using the absorption cross section data found in the literature. The relation obtained here can be generalized as follows. (1) First, the absorption cross section of any kind glass will be measured experimentally in the wavelength range of 900 nm to 1050 nm. (2) Then, calculate the absorption coefficient realizing the required absorption rate from the doping wt. % x and the absorption cross section. Note here that there exists the lower limit of x for realizing the concentration quenching. As Yb is expensive, use this lower limit value for x. (3) Finally, select the wavelength realizing the required absorption rate at this value of x from the data of the absorption cross section and determine the composition of the LD so that this wavelength is obtainable.

In the principle of this embodiment, the 4f electron in Yb ion is excited by the InGaAs laser beam, which is converted into heat via a non-radiative transition. R. Paschotta published the article “Lifetime quenching in Yb-doped fibers” in Optics Communications, Vol. 136 (1997), on page 375 to 378 and reported that when the Yb concentration exceeds 1 wt. %, the electron of the excited Yb ion in the glass undergoes a non-radiative transition, i.e. quenching. Therefore, in the case of non-alkaline glass the doped Yb ions for realizing the full-body scribing do not generate fluorescence but contribute to the scribing. On the contrary, the excessive doping of expensive Yb is not required. The ideal case of the selection of the irradiation laser and the minimum concentration of doping within the range of a non-radiative transition can be realized by the combination consisting of Yb dopant and InGaAs irradiation laser.

Similarly, other combination between either of Nd, Ho or Eb dopant and a proper semiconductor laser for irradiation can be used.

### Tenth Embodiment

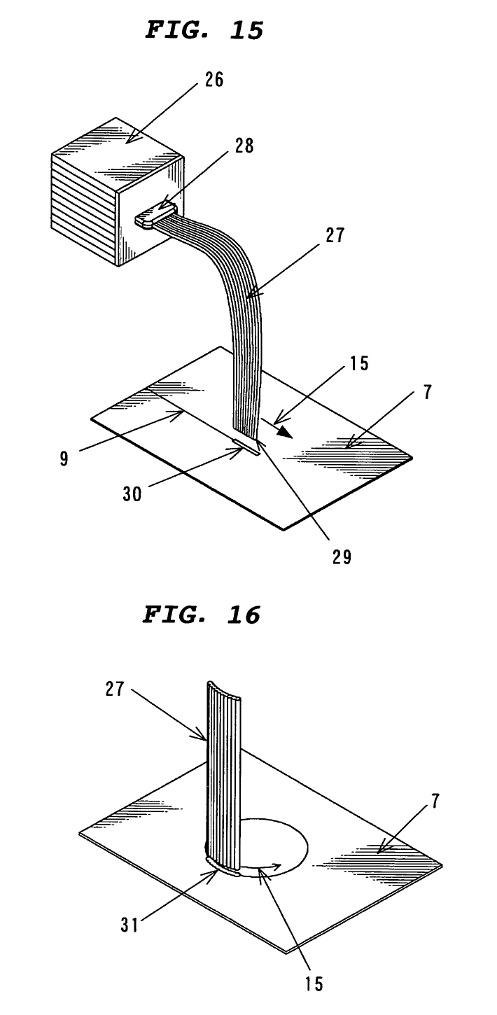

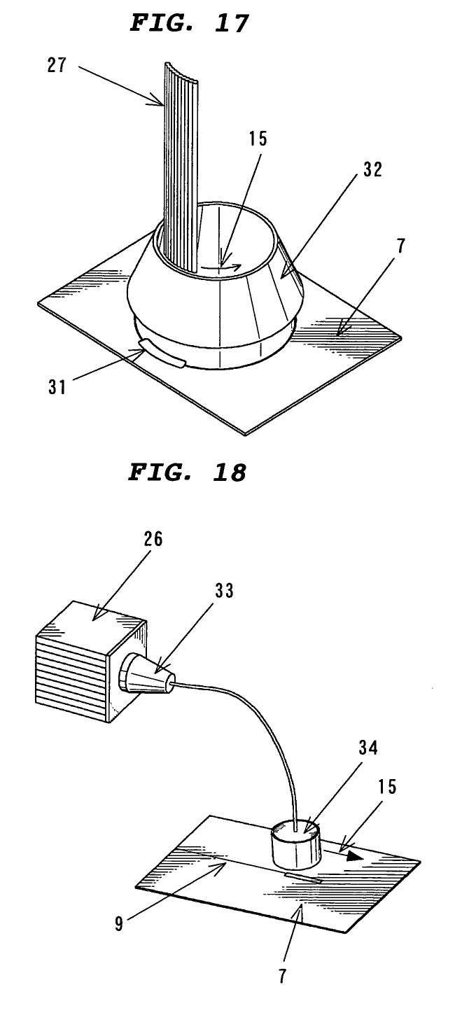

In this invention the beam delivery through optical fibers is possible and the beam emitting ends of the fibers can be so arranged as to form the optimum cross sectional geometry of irradiation for realizing the thermal stress, the description of which has been omitted so far. FIG. 15 shows one example of such cases. In the figure, 26 is a LD stack comprising of many elements and 27 is a fiber bundle composed of fiber elements each delivering the beam from each LD element. The input end of this fiber bundle 28 acts as a connector. At the other end 29 of the bundle, the fibers are so arranged as to form different beam cross sectional geometry. In the figure, the linear geometry 30 is formed to scribe linearly. For circular scribing, the circular geometry 31 shown in FIG. 16 should be used. FIG. 17 shows the magnifying and contracting optics 32 placed between the fiber end and the glass plate, the function of which is to vary the diameter of the circle. In order to scribe realizing a profile other than line or circle, the fiber ends should be arranged according to the desired profile.

FIG. 18 shows a different case. In the figure, the beam is connected into one piece fiber using the beam connector 33 and is converted into the beam possessing the optimum cross sectional geometry using the optics 34 acting as the cross sectional geometry converter.

When light propagates in glass, the intensity of generated heat decreases exponentially as a function of distance as is clear from Eq. (1). Even in this case, the full-body scribing is possible. However, the uniform heat generation is desirable in view of achieving the ideal scribing. The uniform heat generation can be realized by doping the glass, the concentration of which follows the inversely exponential distribution.

In this embodiment, the heat is the penetrating kind and the thermal conduction is not required. As the total laser power should better be reduced as much as possible and, therefore, the width of the cross sectional geometry should better be reduced. The disk laser configuration is desirable here.

The cooling of the glass plate, which helps scribing, should better be performed on both of the front as well as rear surfaces in order to realize uniform effect.

### Eleventh Embodiment

The embodiment 11 relates to the full-body scribing of a piled glass plate, which is actually used in commercial flat panel displays. In the explanation of this invention so far, all the works selected were one-sheet glass plates. This invention, on the other hand, can deal with a piled work comprising of plural number of glass sheets, which is very useful in the manufacturing of commercial products. In this embodiment, the beam penetrating and being absorbed partially through more than two sheets of glass is used. Most of the beams introduced so far can be used as such.

When such a beam is absorbed in the work, the tensile thermal stress is generated. The intensity of the stress is so controlled that it can cause scribing only when assisted by the presence of crack. The selective scribing is realized by the presence of crack where the scribe is desired.

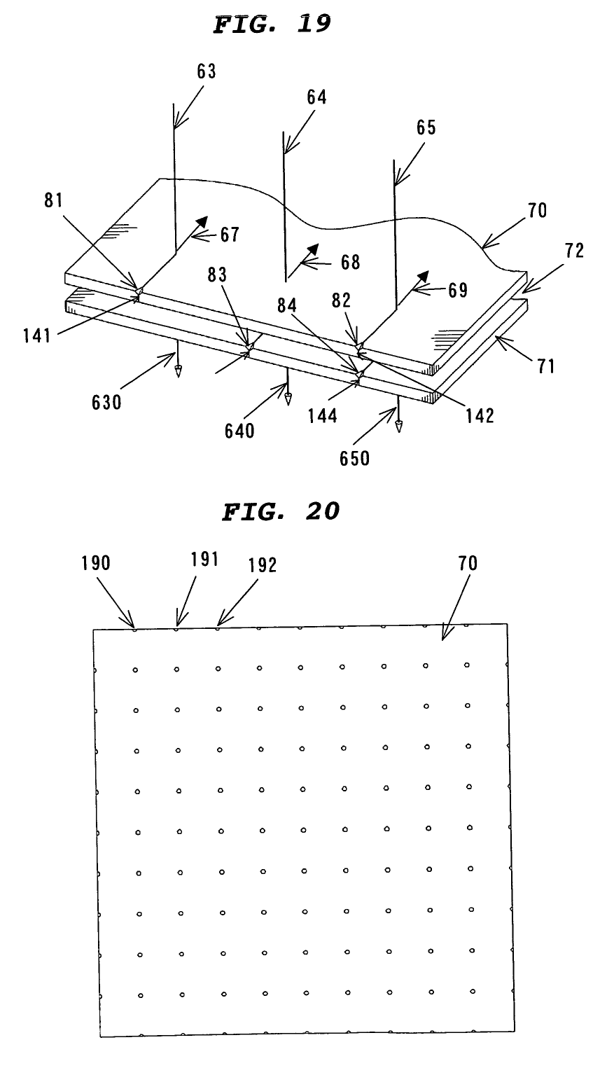

FIG. 19 shows the case consisting of the two glass plates 70 and 71 and the gap 72, which is placed therebetween. The gap layer can contain LC and is air-filled at the places to scribe. In this figure, it is the air gap. The incoming laser beams 63, 64 and 65 are scanned in the directions of 67, 68 and 69.

The incoming beams penetrate the plates 70 and 71 and are partially absorbed in them. The transmitted beams are denoted as 630, 640 and 650. The initial cracks 81 and 82 are prepared in the plate 70 and the ones 83 and 84 in the plate 71 for initiating the scribing.

When the beam 63 is scanned, its intensity is so selected that the formed thermal stress is below the cleavage toughness of the work without the assistance of crack and above it when the assistance exists. The cooling after the beam irradiation can enhance the stress formation. The cooling from both the surfaces is better. The glass plate 70 undergoes scribing 141 due to the presence of the crack 81, while the plate 71 does not undergo scribing due to the absence of crack.

The case of the beam 64 results only in the scribing 143 of the plate 71 due to the presence of the crack 83.

The case of the beam 65 results in the scribings 142 and 144 of both the plates due to the presence of the cracks 82 and 84.

As is explained, the present invention enables the selective scribing in both of the plates 70 and 71 by preparing the initial cracks only where the scribing is required. It possesses the advantage that the irradiation of the beam can be performed in one direction and furthermore the mechanical breaking is not necessary.

In the actual configuration of commercial LC flat panels, the scribing of each plates should be done at different positions due to the existence of electrode for which this invention is useful.

The initial cracks 81, 82, 83 and 84 can be formed by means of the conventional diamond-tip method or can be formed by utilizing pulsed laser beam. The formation can be prepared prior to the scribing process and the scribing can afterward be done, which shortens the entire process time.

FIG. 20 shows the case in which the formation of the initial cracks 190, 191, 192, etc in the glass plate 70 is done by using a point scriber utilized in the processing of semiconductor wafer. The use of diffractive optical element together with pulsed laser beam irradiation is also feasible.

As has been explained so far, this invention reduces the conventional two-step process consisting of laser scribing and mechanical breaking into one-step process consisting of laser scribing only. Its direct advantages for the manufacturing of LC flat panel displays include the followings.
1) Higher geometrical accuracy.
2) Higher scribed surface quality as good as mirror finished surface.
3) Absence of generation of micro crack during processing.
4) Absence of generation of caret and other contaminants during processing.
5) Process automation feasible.
6) High velocity processing.
7) Dispensing with subsequent processing such as polishing and cleaning.
8) Selective scribing in pile-structured plate.
9) Profile scribing feasible.

The present invention possesses the following general advantages, too.
1) The processing of multi-layer piled glass plate can be done.
2) The processing of micro-chip work can be done, paving the way to the electronics industry.
3) The processing of tempered glass plate can be done, paving the way to the architectural industry.
4) The processing of curved glass plate can be done, paving the way to the automobile industry.

When the laser glass scribing technology spreads into the various sectors of industry, the process improvement expected in velocity, quality, economy, simplification, etc. will be considerable.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed is:

1. A method for scribing fragile material comprising the steps of;
laser beam irradiation onto the work plate of fragile material, with or without subsequent cooling,
heating of the work by the absorption of the irradiated beam and generation of the thermal stress arising from the heating, which exceeds the cleavage toughness of the material where the scribing is required and resulting full-body scribing, which covers the entire thickness of the work and;
controlling absorption coefficient a (cm⁻¹) of the material so as to satisfy the inequality of 0.105/L<a<18.42/L with L (cm) which is the thickness of the work.

2. The method of claim 1, wherein the cooling is done from both the work surfaces of front as well as rear one.

3. The method of claim 1, wherein controlling the absorption coefficient a is done by selecting wavelength of the irradiation laser beam.

4. The method of claim 3, wherein the irradiation laser beam is selected from among either of CO₂ laser beam, CO laser beam, Er:YAG laser beam, Ho:YAG laser beam, Nd:YAG laser beam, Yb:YAG laser beam or harmonics of these laser beams.

5. The method of claim 3, wherein the wavelength selection of the irradiation laser beam is done by selecting wavelength of an optical parametric oscillation.

6. The method of claim 5, wherein the selection of the wavelength of an optical parametric oscillation is performed by generating signal or idler in an optical parametric oscillator, which is generated by either of angular control of critical phase matching, temperature control of non-critical phase matching or periodic control of quasi-phase matching of periodic depolarization inversion structure when YAG laser beam is irradiated onto a non-linear crystal for excitation.

7. The method of claim 3, wherein the wavelength selection of the irradiation beam is done by varying composition in a mixed crystal semiconductor laser consisting of plural number of compound semiconductors.

8. The method of claim 7, wherein the mixed crystal semiconductor is either of PbEuSeTe, InAsSbP, InGaAsSb or AlInAsSb.

9. The method of claim 3, wherein the wavelength selection of the irradiation beam is done by selecting one of mixed crystal semiconductor lasers, each of which generates laser beams having wavelength suitable for each of different work thicknesses.

10. The method of claim 1, wherein controlling the absorption coefficient a is done by doping work material with impurity, which absorbs irradiation beam and heats the material without generating fluorescence, and not generate either of optical absorption or emission in the visible spectral range for effecting display characteristics of a device including the material.

11. The method of claim 10, wherein the impurity is water and the laser for irradiation is either of Er:YAG laser or Ho:YAG laser.

12. The method of claim 10, wherein the impurity is rare-earth element atom such as Nd, Yb, Ho or Er and the laser for irradiation is selected from among Nd:YAG laser, Yb:YAG laser, Ho:YAG laser or Er:YAG laser corresponding to the same element.

13. The method of claim 10, wherein the impurity is rare-earth element atom possessing multiple energy levels of the gap smaller than that of fluorescent energy levels for quenching the fluorescence.

14. The method of claim 13, wherein the rare-earth element atom is selected from among Pr, Sm, Dy, Nd or Eu.

15. The method of claim 10, wherein the impurity is doped with high concentration to occur fluorescence quenching by concentration quenching.

16. The method of claim 10, wherein the impurity is rare-earth element atom, and a semiconductor laser beam is irradiated for exciting 4f electrons in the rare-earth element ions formed in the atoms, which leads to non-radiative deactivation and heating the working material.

17. The method of claim 16, wherein the rare-earth element atom is Yb and the semiconductor laser is InGaAs laser.

18. The method of claim 10, wherein the impurity is one or both of beam absorbing dopant and fluorescence quenching dopant, the concentration distribution of at least one of the beam absorbing dopant and fluorescence quenching dopant is selected to be inversely exponential in the direction of the beam penetration so that the distribution of the heat generation from the exponentially decreasing penetrating beam becomes uniform in the thickness direction of the work.

19. A method for scribing a piled fragile material comprising the steps of;
laser beam irradiation onto a work plate of the piled fragile material with or without subsequent cooling,
heat generation as the result of beam absorption to form thermal stress in the plate, which scribes only in the plate where the initial crack is prepared beforehand and does not scribe in the plate where the crack is not prepared.

20. The method of claim 19, wherein the formation of initial crack is done by means of the mechanical method such as using diamond tip.

21. The method of claim 19, wherein the formation of initial crack is done by means of the laser beam irradiation.

22. An apparatus for scribing fragile material comprising;
LD elements comprising a LD stack,
an optical fiber bundle provided for delivering each of beam from each of the LD elements through each element of the optical fiber bundle, in the emission end of which the elementary fiber ends are so arranged that the cross-sectional geometry of the total beam is formed to be suitable to the scribing.

23. The apparatus of claim 22, wherein the arrangement of the fiber ends is linear.

24. The apparatus of claim 22, wherein the arrangement of the fiber ends is circular.

25. The apparatus of claim 24, wherein a magnifying and contracting optics is mounted at the fiber ends.

26. The apparatus of claim 22, wherein irradiation laser beam from the LD stack is connected into a single optical fiber for delivery the emission end of which is scanned using a control optics so that the cross sectional geometry of the scanned beam is formed to be suitable to the scribing.
